(19) United States
(12) Patent Application Publication
(10) Pub. No.: US 2011/0266431 A1
(43) Pub. Date: Nov. 3, 2011

(54) Tandem TOF Mass Spectrometer With High Resolution Precursor Selection And Multiplexed MS-MS And MS-MS Operation

(75) Inventor: Marvin L. Vestal, Framingham, MA (US)

(73) Assignee: VIRGIN INSTRUMENTS CORPORATION, Sudbury, MA (US)

(21) Appl. No.: 12/770,794

(22) Filed: Apr. 30, 2010

(51) Int. Cl. H01J 49/40

(52) U.S. Cl. 250/282; 250/287

(57) ABSTRACT

A tandem time-of-flight mass spectrometer includes a first TOF mass analyzer that generates an ion beam comprising a plurality of precursor ions and that selects a group of precursor ions from the plurality of precursor ions. A first pulsed ion accelerator accelerates the selected group of precursor ions. A first ion fragmentation chamber fragments at least some of the selected group of precursor ions. A second pulsed ion accelerator accelerates the selected group of precursor ions and fragments thereof. A second ion fragmentation chamber further fragments at least some of the selected group of precursor ion fragments. A second TOF mass analyzer separates the fragments and detects a fragment ion mass spectrum.

The section headings used herein are for organizational purposes only and should not to be construed as limiting the subject matter described in the present application in any way.

### INTRODUCTION

Many mass spectrometer applications require an accurate determination of the molecular masses and relative intensities of metabolites, peptides, and intact proteins in complex mixtures. Tandem mass spectrometry provides information on the structure and sequence of many biological polymers and allows unknown samples to be accurately identified. Tandem mass spectrometers employ a first mass analyzer to produce, separate and select a precursor ion, and a second mass analyzer to fragment the selected ions and record the fragment mass spectrum from the selected precursor. A wide variety of mass analyzers and combinations thereof for use in tandem mass spectrometry are known in the literature.

For some measurements the fragment spectra generated by tandem mass spectrometry (MS-MS) is insufficient to determine the molecular structure and an additional stage of fragmentation, such as MS-MS-MS, is required. For these measurements, a first fragment of a selected precursor ion is further fragmented and the fragment spectrum of the first fragment ion is then recorded and interpreted.

An important advantage of TOF Mass Spectrometry (MS) is that essentially all of the ions produced are detected, which is unlike scanning MS instruments. This advantage is lost in conventional MS-MS instruments where each precursor ion is selected sequentially and all non-selected ions are lost. This limitation can be overcome by selecting multiple precursor ions following each laser shot and recording fragment spectra from each precursor ion can partially overcome this loss and dramatically improve speed and sample utilization without requiring the acquisition of raw spectra at a higher rate.

Several approaches to matrix assisted laser desorption/ionization (MALDI)-TOF MS-MS are described in the prior art. All of these approaches are based on the observation that at least a portion of the ions produced in the MALDI ion source may fragment as they travel through a field-free region. Ions may be energized and fragment as the result of excess energy acquired during the initial laser desorption process, or by energetic collisions with neutral molecules in the plume produced by the laser, or by collisions with neutral gas molecules in the field-free drift region. These fragment ions travel through the drift region with approximately the same velocity as the precursor ion, but their kinetic energy is reduced in proportion to the mass of the neutral fragment that is lost. A timed-ion-selector may be placed in the drift space to transmit a small range of selected ions and to reject all others. In a TOF mass analyzer employing a reflector, the lower energy fragment ions penetrate less deeply into the reflector and arrive at the detector earlier in time than the corresponding precursors. Conventional reflectors focus ions in time over a relatively narrow range of kinetic energies. Thus, only a small mass range of fragments are focused for given potentials applied to the reflector.

In work by Spengler and Kaufmann, the limitation in mass range was overcome by taking a series of spectra at different mirror voltages and piecing them together to produce the complete fragment spectrum. An alternate approach is to use a “curved field reflector” that focuses the ions in time over a broader energy range. The TOF-TOF approach employs a pulsed accelerator to re-accelerate a selected range of precursor ions and their fragments so that the energy spread of the fragments is sufficiently small that the complete spectrum can be adequately focused using a single set of reflector potentials.

All of these approaches have been used to successfully produce MS-MS spectra following MALDI ionization, but each suffers from serious limitations that have stalled widespread acceptance. For example, each approach involves relatively low-resolution selection of a single precursor, and the generation of the MS-MS spectrum for that precursor ion, while ions generated from other precursor ions present in the sample are discarded. Furthermore, the sensitivity, speed, resolution, and mass accuracy for the first two techniques are inadequate for many applications.

### BRIEF DESCRIPTION OF THE DRAWINGS

The present teachings, in accordance with preferred and exemplary embodiments, together with further advantages thereof, is more particularly described in the following detailed description, taken in conjunction with the accompanying drawings. The skilled person in the art will understand that the drawings, described below, are for illustration purposes only. The drawings are not necessarily to scale, emphasis instead generally being placed upon illustrating principles of the invention. The drawings are not intended to limit the scope of the Applicant's teachings in any way.

FIG. 1 shows a block diagram of one embodiment of a tandem TOF-TOF mass spectrometry with high resolution precursor selection and multiplexed MS-MS and MS-MS-MS according to the present teaching.

FIG. 2 shows a schematic diagram of a tandem TOF mass spectrometer with high resolution precursor selection and multiplexed MS-MS-MS according to the present teaching.

FIG. 3 shows a potential diagram for a portion of the second time-of-flight analyzer according to one embodiment of the present invention.

FIG. 4 shows a block diagram of a tandem TOF mass spectrometer with high resolution precursor selection and multiplexed MS-MS and MS-MS-MS operation according to the present teaching.

FIG. 5 shows a schematic diagram of another embodiment of a tandem TOF-TOF mass spectrometer with high resolution precursor selection and multiplexed MS-MS and MS-MS-MS according to the present teaching.

FIG. 6 shows a potential diagram for a portion of the first time-of-flight mass analyzer in the tandem TOF mass spectrometer with high resolution precursor selection and multiplexed MS-MS operation.

### DESCRIPTION OF VARIOUS EMBODIMENTS

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

It should be understood that the individual steps of the methods of the present teachings may be performed in any order and/or simultaneously as long as the invention remains operable. Furthermore, it should be understood that the apparatus and methods of the present teachings can include any number or all of the described embodiments as long as the invention remains operable.

The present teachings will now be described in more detail with reference to exemplary embodiments thereof as shown in the accompanying drawings. While the present teachings are described in conjunction with various embodiments and examples, it is not intended that the present teachings be limited to such embodiments. On the contrary, the present teachings encompass various alternatives, modifications and equivalents, as will be appreciated by those of skill in the art. Those of ordinary skill in the art having access to the teachings herein will recognize additional implementations, modifications, and embodiments, as well as other fields of use, which are within the scope of the present disclosure as described herein.

The present teaching relates to apparatus and methods for rapidly and accurately determining mass-to-charge ratios of molecular ions and fragments thereof produced by a pulsed ionization source. The apparatus of the present teaching can operate in various modes of operation including, but not limited to MS, MS-MS, and MS-MS-MS modes of operation.

The apparatus of the present teaching can also provide high-resolution precursor selection with MALDI MS-MS. Single isotopes can be selected and fragmented up to m/z 4000 with no detectable loss in ion transmission and less than 1% contribution from adjacent masses. Also, the methods and apparatus of the present teaching can provide up to 50 fold multiplexing in both MS-MS and MS-MS-MS modes of operation. This allows the generation of very high quality MS-MS and MS-MS-MS spectra at very high speed. In addition, the methods and apparatus of the present teaching allow simultaneous optimization of the performance for each of the mass analyzers.

In particular, the methods and apparatus of the present teaching allow all of the peptides present in complex peptide mass fingerprints, which can contain a hundred or more peaks, to be fragmented and identified without exhausting the sample. This allows speed and sensitivity of the MS-MS and MS-MS-MS measurements to keep pace with the MS results. The combination of high-resolution precursor selection with high laser repetition rates and multiplexed operation allows high-quality, interpretable MS-MS and MS-MS-MS spectra to be generated on detected peptides with very high sensitivity.

For multiplex operation, a predetermined group of precursor ions are selected following each laser pulse. Each ion in the predetermined group is selected by the first timed ion selector and all others are rejected. In the MS-MS mode of operation, the selected ions are fragmented and the fragment ions are analyzed in the second mass spectrometer. In the MS-MS-MS mode of operation, the selected precursor ions are fragmented in a first ion fragmentation chamber, and the selected precursor ions and fragments thereof are accelerated by a pulsed accelerator causing the selected precursor ions and associated fragments to separate in time as they pass through a second ion fragmentation chamber. A second timed ion selector selects predetermined fragments from the first ion fragmentation chamber and transmits selected ions and fragments formed in the second ion fragmentation chamber to the second mass spectrometer to generate the MS-MS-MS spectra. Multiple fragments from each precursor ion can be selected and further fragmented to allow multiplex operation in MS-MS-MS mode.

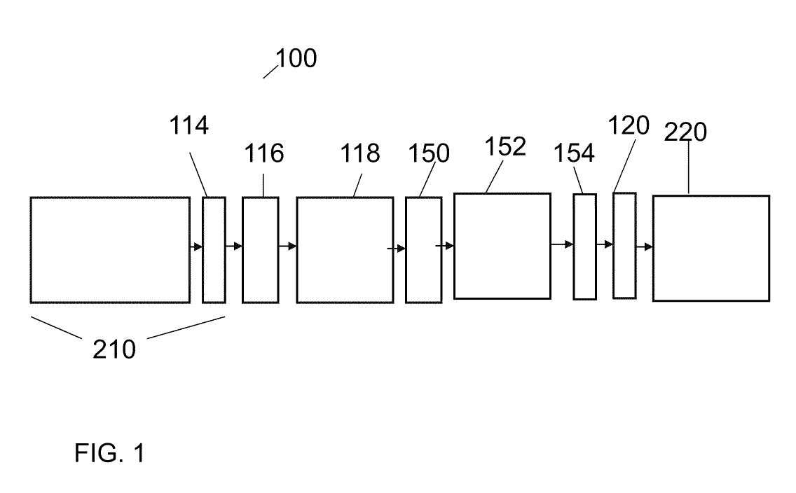

FIG. 1 shows a block diagram of a tandem TOF mass spectrometer 100 with high resolution precursor selection and multiplexed MS-MS according to the present teaching. The tandem TOF mass spectrometer 100 includes a first high resolution TOF mass analyzer 210 for separating precursor ions according to their mass-to-charge ratio. The first high resolution TOF mass analyzer 210 includes a first timed ion selector 114 for selecting separated precursor ions, and a first pulsed accelerator 116 that accelerates the precursor ions to reduce the velocity spread of selected ions.

A first ion fragmentation chamber 118 fragments the selected precursor ions. A second pulsed ion accelerator 150 accelerates and focuses precursor ions and fragment ions from the first ion fragmentation chamber 118. A second ion fragmentation chamber 152 further fragments precursor ions and fragment ions accelerated by the second pulsed ion accelerator 150. A second timed ion selector 154 selects fragment ions formed by fragmentation of selected precursor ions in the first ion fragmentation chamber 118 and transmits selected ions and fragments thereof from second fragmentation chamber 152 to a third pulsed accelerator 120 that accelerates and focuses fragment ions exiting the second ion fragmentation chamber 152.

A second high resolution TOF mass analyzer 220 separates fragment ions from each selected precursor ion according to the mass-to-charge ratio of the fragments and detects and records the mass spectra of the fragment ions. A unique feature of the tandem TOF mass spectrometer 100 is that mass resolving power and sensitivity of both the first 210 and the second 220 high resolution mass analyzers can be simultaneously optimized.

In one embodiment, an ion detector (not shown) is mounted adjacent to the timed ion selector 114 on a moveable mount that allows the first high resolution TOF mass analyzer 210 to be operated as a high resolution TOF mass spectrometer for recording the spectrum of ions generated in the ion source. This spectrum includes accurate measurement of the flight times for all ions detected in the spectrum and allows very accurate calibration of the time delays employed in selecting predetermined precursor ions.

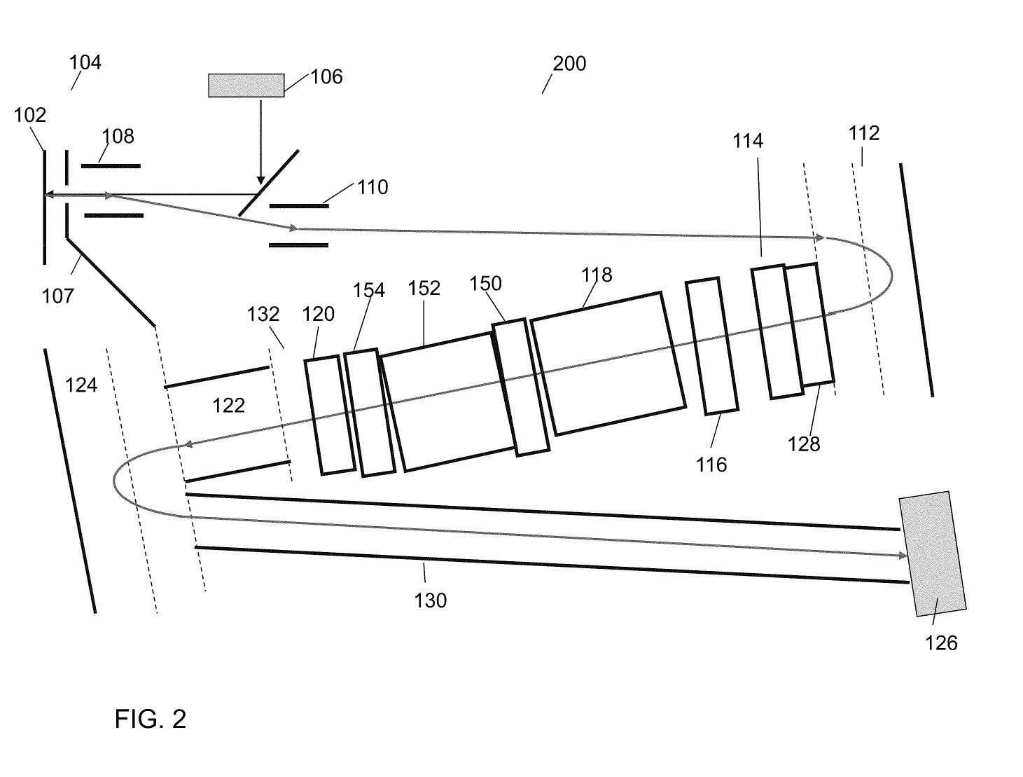

FIG. 2 shows a schematic diagram of a tandem TOF mass spectrometer 200 with high resolution precursor selection and multiplexed MS-MS-MS according to the present teaching. The mass spectrometer 200 includes a sample plate 102 that is installed on a precision x-y table which allows a laser beam to raster over the sample plate 102 at any speed up to about 20 mm/sec although higher speeds are possible. The source vacuum housing (not shown) containing the mass spectrometer 200 includes a means for quickly changing the sample plate 102 without venting the system.

The mass spectrometer 200 includes a laser desorption pulsed ion source 104. In one embodiment, the pulsed ion source 104 comprises a two-field pulsed ion source. The pulsed ion source 104 includes a laser 106 that irradiates a sample positioned on the sample plate 102 to generate ions. For example, one suitable laser 106 is a frequency tripled Nd:YLF laser operating at 5 kHz. In some embodiments, the pulsed ion source 104 comprises a matrix-assisted laser desorption/ionization (MALDI) pulsed ion source. However, it should be understood that non-MALDI pulsed ion sources can be used with the mass spectrometer of the present invention.

Ion source optics is positioned after the ion source 104. The ion source optics is designed for high-resolution mass spectra measurements. An extraction electrode 107 is positioned adjacent to the sample plate 102. A first 108 and a second ion deflector 110 are positioned after the pulsed ion source 104 in the path of the ion beam. The first and second ion deflectors 108, 110 deflect the ion beam to a first two-stage mirror 112 that is positioned in the path of the ion beam.

In some embodiments, the first and second ion deflectors 108, 110 deflect the ion beam at a predetermined angle that reduces ion trajectory errors that limit the resolving power of the mass spectrometer 200. In some embodiments, the second ion deflector 110 deflects the ions at a relatively wide angle compared with known time-of-flight mass spectrometers. In some embodiments, X-Y ion beam steering electrodes 128 are positioned near the output of the first ion mirror 112. The X-Y ion beam steering electrodes 128 can be used to correct for minor misalignments of the components in the mass analyzer section of the mass spectrometer 200.

A timed ion selector 114 is positioned in the field-free space after the output of the first ion mirror 112. In one embodiment, the timed ion selector 114 is a Bradbury-Nielsen type ion shutter or ion gate. A Bradbury-Nielsen type ion shutter or ion gate is an electrically activated ion gate. Bradbury-Nielsen timed ion selectors include parallel wires that are positioned orthogonal to the path of the ion beam. High-frequency voltage waveforms of opposite polarity are applied to alternate wires in the gate. The gates only pass charged particles at certain times in the waveform cycle when the voltage difference between wires is near zero. At other times, the ion beam is deflected to some angle by the potential difference established between the neighboring wires. The wires are oriented so that ions rejected by the timed ion selector 114 are deflected away from the exit aperture.

The first ion mirror 112 focuses the ion beam at the timed ion selector 114. The timed ion selector 114 passes a desired mass-to-charge ratio range of precursor ions and rejects other ions in the ion beam. The ions passed by the timed ion selector 114 enter into a first pulsed ion accelerator 116 where selected ions are accelerated and their velocity distribution is substantially altered. A first ion fragmentation chamber 118 is positioned proximate to the output of the first ion accelerator 116. One skilled in the art will appreciate that any type of ion fragmentation chamber can be used. In one embodiment, the ion fragmentation chamber 118 is a collision cell containing a collision gas and an RF-excited octopole that guides fragment ions. The first ion fragmentation chamber 118 fragments some of the precursor ions. Precursor ions and fragments thereof exit the fragmentation chamber 118. A differential vacuum pumping system can be included that prevents excess collision gas from significantly increasing pressure in the tandem TOF mass spectrometer.

A second pulsed ion accelerator 150 is positioned at the output of the first ion fragmentation chamber 118. The second pulsed ion accelerator 150 accelerates and focuses precursor ions and fragment ions that exit the first ion fragmentation chamber 118. A second ion fragmentation chamber 152 further fragments precursor ions and fragments ions that are accelerated by the second pulsed ion accelerator 150. A second timed ion selector 154 selects fragment ions formed by fragmentation of selected precursor ions in the first ion fragmentation chamber 118 and transmits selected ions and fragments thereof from the second fragmentation chamber 152 to a third pulsed accelerator 120 that accelerates and focuses fragment ions exiting the second ion fragmentation chamber 152. In one embodiment, the third pulsed ion accelerator 120 further accelerates the ions and fragments thereof using a static electric field in region 132.

A second ion mirror 124 is positioned after the pulsed ion accelerator 120 and a first electric field-free region 122. An ion detector 126 is positioned after the second ion mirror 124 in a second electric field-free region 130. The second ion mirror 124 is positioned such that ions reflected by the second ion mirror 124 are focused at an ion detector 126. In one embodiment, the ion detector 126 is a discrete dynode electron multipliers, such as the MagneTOF detector, which is a sub-nanosecond ion detector with high dynamic range. The MagneTOF detector is commercially available from ETP Electron Multipliers. The ion detector 126 can be coupled to a transient digitizer, which can perform signal averaging.

It should be understood by those skilled in the art that the schematic diagram shown in FIG. 2 is only a schematic representation and that various additional elements would be necessary to complete a functional mass spectrometer. For example, power supplies are required to power the pulsed ion source 104, the ion deflectors 108, 110, the timed ion selector 114, the first and second ion mirrors 112, 124, the pulsed accelerator 120, and the ion detector 126. In addition, a vacuum pumping arrangement is required to maintain the operating pressures in the vacuum chamber housing of the mass spectrometer 100 at the desired operating levels.

The mass spectrometer 200 provides high mass resolving power for precursor selection and for MS, MS-MS and MS-MS-MS spectra. In various embodiments, the mass spectrometer 200 can be configured for either positive or negative ions, and can be readily switched from one type of ion to the other type of ions in a short amount of time.

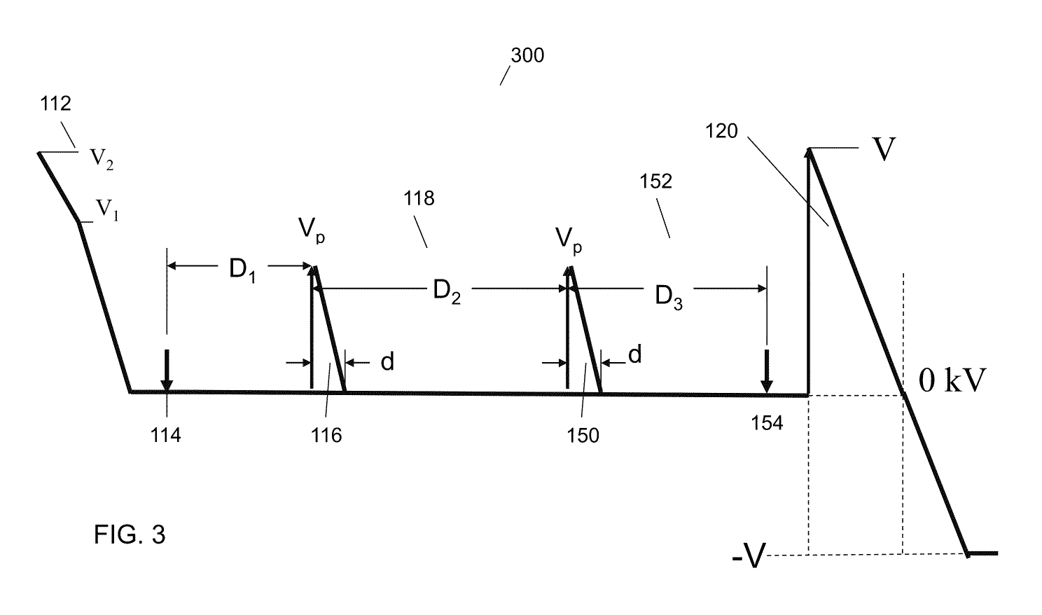

FIG. 3 shows a potential diagram 300 for a portion of the second time-of-flight mass analyzer according to one embodiment of the present invention. Referring to FIGS. 1 and 2 and to the potential diagram 300 shown in FIG. 3, when an ion selected by the timed ion selector 114 substantially reaches the center of the first pulsed accelerator 116, an accelerating voltage pulse Vₚ is applied to the ion accelerator 116. If the ratio of the amplitude of the accelerating pulse Vₚ relative to the energy Vₒ of ions exiting the mirror is equal to 4d/D₁, where d is the length of the first pulsed accelerator 116, and D₁ is the distance from the timed ion selector 114 to the center of the first pulsed ion accelerator 116, then the velocity spread of the ions exiting the first pulsed ion accelerator 116 is substantially reduced to zero and the velocity focus approaches infinity.

At higher pulse amplitude Vₚ the velocity distribution is inverted and the velocity focus may be made to occur at any required distance. At lower pulse amplitudes, the velocity distribution is broadened. After focusing with the first pulsed accelerator, the velocity distribution is reduced by the factor (D₂/D₁)(1+4d/D₁)^{1/2} where D₂ is the distance from the center of the first pulsed accelerator 116 to the entrance to the second pulsed accelerator 150. In one embodiment, the distance D₂ from the first pulsed accelerator 116 to the second pulsed accelerator 150 is more than 10 times the distance D₁ from the timed ion selector 114 to the first pulsed accelerator 116. Thus, a relatively broad velocity distribution at the exit from the first TOF mass analyzer 210 can be effectively removed allowing high performance in both analyzers.

For MS-MS operation, the second pulsed accelerator 150 is not activated. The operating conditions for the first pulsed accelerator 116 can be adjusted to minimize the velocity spread at the second timed ion selector 154. The second timed ion selector 154 selects precursor ions and fragments thereof formed in both the first and the second ion fragmentation chamber 118 and 152 and transmits selected ions and fragments thereof to third pulsed accelerator 120 that accelerates and focuses fragment ions exiting the second ion fragmentation chamber 152.

Thus, tandem TOF mass spectrometers according to the present invention include a MALDI ion source, a first TOF mass analyzer for separating precursor ions, a timed ion selector for selecting predetermined precursor ions, a first pulsed ion accelerator for reducing the velocity spread of selected ions, an ion fragmentor, and second TOF mass analyzer for determining the mass-to-charge ratio spectrum of the fragment ions. The dual Bradbury-Nielson gate provides the performance needed for high resolution selection of a large number of precursor ions for multiplex operation of the tandem TOF mass spectrometer.

One aspect of the present teaching is the design of a tandem TOF mass spectrometer where the ion source 104 conditions are adjusted to optimize the performance of the first TOF mass analyzer 210. The first TOF mass analyzer is designed so that the first ion mirror 112 refocuses the ion beam from the source focus Dᵥ to the timed ion selector 114 without increasing the other contributions to peak width. The first pulsed accelerator 116 refocuses the selected ions so that optimal performance of the second TOF mass analyzer 220 for separating and analyzing fragment ions in both MS-MS and MS-MS-MS modes can be obtained simultaneously with optimal performance of the first mass analyzer for selecting precursor ions.

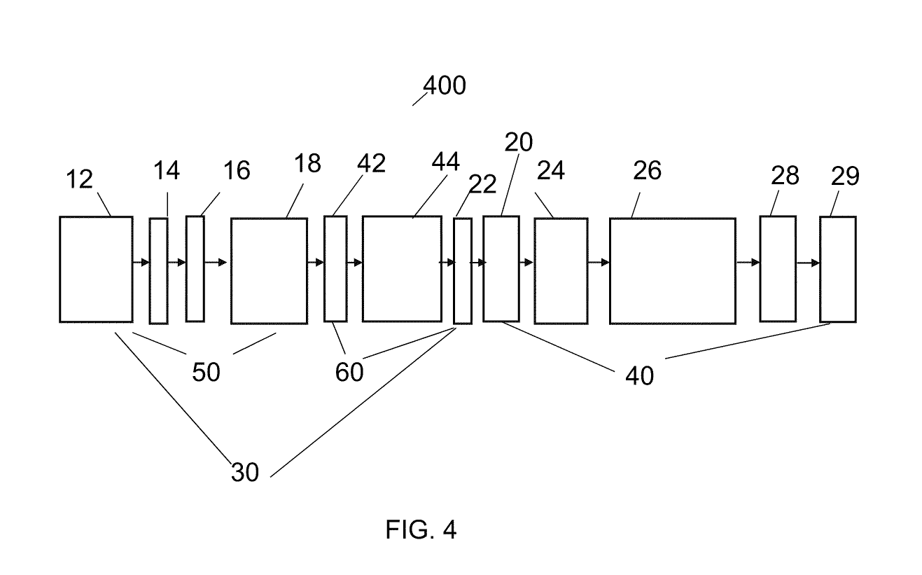

FIG. 4 shows a block diagram of a tandem TOF mass spectrometer 400 with high resolution precursor selection and multiplexed MS-MS and MS-MS-MS operation according to the present teaching. The tandem TOF mass spectrometer 400 includes a pulsed ion source 12. A first timed ion selector 14 is positioned after the pulsed ion source 12 in the flight path of the pulse. A first pulsed ion accelerator 16 is positioned after the first timed ion selector 14 in the flight path of the selected ions. A first ion fragmentation chamber 18 is positioned after the first pulsed ion accelerator 16 in the flight path of the ions accelerated by the first pulsed ion accelerator 16.

A second pulsed ion accelerator 42 is positioned after the first ion fragmentation chamber 18 in the flight path of the fragmented ions. A second ion fragmentation chamber 44 is positioned after the second pulsed ion accelerator 42 in the path of the ions and associated fragments accelerated by the second pulsed ion accelerator 42.

A second timed ion selector 22 is positioned after the second ion fragmentation chamber 44 in the path of the fragmented ions. A third pulsed ion accelerator 20 is positioned after the second timed ion selector 22 in the path of the selected ions. An ion mirror 24 is positioned after the third pulsed ion accelerator 20 in the path of the accelerated ions to reflect the ions to a field-free drift space 26 and then to an ion detector 28 and a processor 29.

A first high resolution TOF mass spectrometer 50 includes the combination of the pulsed ion source 12, the first timed ion selector 14, the first pulsed ion accelerator 16, and the first ion fragmentation chamber 18. The first high resolution mass spectrometer 50 selects and fragments multiple precursor ions following each ion pulse from pulsed ion source 12.

The second high resolution TOF mass spectrometer 60 includes the combination of the second pulsed ion accelerator 42, the second ion fragmentation chamber 44, and the second timed ion selector 22. The second high resolution mass spectrometer 60 selects and fragments multiple fragments from each precursor selected by the first timed ion selector 14 and then directs the fragment ions to the third pulsed accelerator 20.

The third high resolution TOF mass spectrometer 40 includes the third pulsed accelerator 20, the ion mirror 24, the field-free drift space 26, and the ion detector 28 and processor 29. The third high resolution TOF mass analyzer 40 separates fragment ions from each selected precursor ion and fragments thereof according to the mass-to-charge ratio of the fragments and then detects and records the mass spectra of the fragment ions. One feature of the tandem TOF mass spectrometer 400 of FIG. 4 is that the mass resolving power and sensitivity of each of the first 50, second 60, and third 40 high resolution TOF mass analyzers can be simultaneously optimized for MS-MS-MS operation. For MS-MS operation, the second pulsed ion accelerator 42 is inactivated, and the first 30 and second 40 high resolution TOF mass analyzers can be simultaneously optimized.

In operation, the pulsed ion source 12 produces a pulse of ions. The first timed ion selector 14 selects a group of ions with predetermined values of mass-to-charge ratio. The first timed ion selector 14 directs the selected ions to a first pulsed ion accelerator 16 and deflects all other ions away. The first pulsed ion accelerator 16 accelerates the selected ions thereby reducing the velocity spread of the selected ions and directing the ions to a first ion fragmentation chamber 18. The first ion fragmentation chamber 18 fragments the selected ions.

The second pulsed ion accelerator 42 accelerates the ions and their corresponding fragments exiting the first ion fragmentation chamber 18. The second ion fragmentation chamber 44 fragments the accelerated ions and associated fragments. The third timed ion selector 22 selects ions with predetermined values of mass-to-charge ratio and their corresponding fragments. Selected ions and fragments thereof are further accelerated by the third pulsed ion accelerator 20. The ion mirror 24 reflects the accelerated ions and then directs them to through the field-free drift space 26 to the ion detector 28 where they are detected and processed by the processor 29. The processor 29 can be used for interpreting the fragment ion mass spectrum to simultaneously identify molecules of interest.

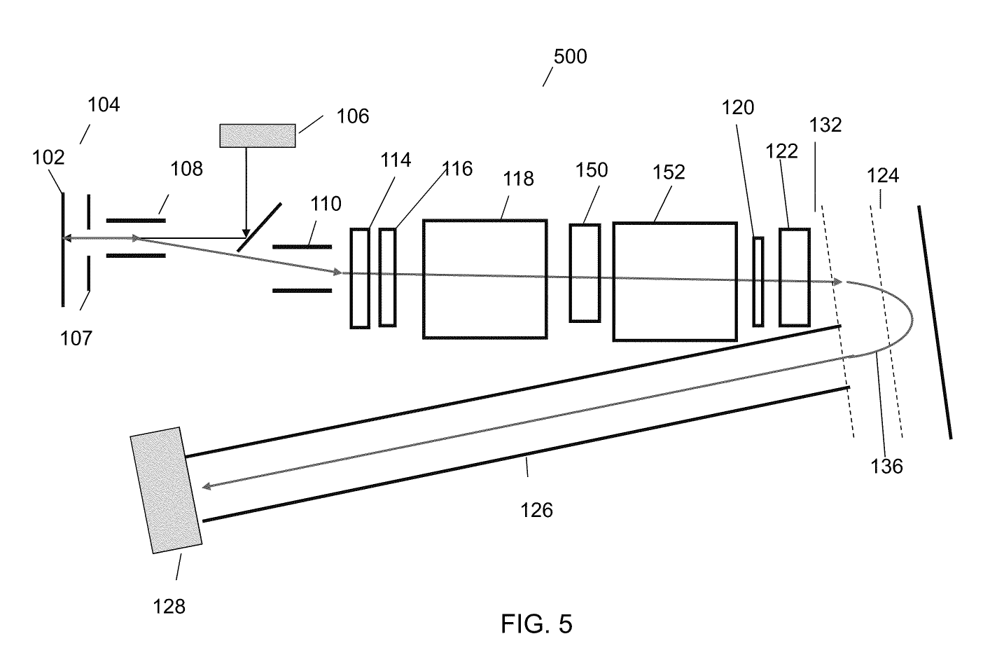

FIG. 5 shows a schematic diagram of a tandem TOF mass spectrometer 500 with high resolution precursor selection and multiplexed MS-MS operation according to the present teaching. The mass spectrometer 500 includes a sample plate 102 that is installed on a precision x-y table which allows a laser beam to raster over the sample plate 102 at any speed. For example, the laser beam rasters over the sample plate 102 at speeds up to about 20 mm/sec in one embodiment, but higher raster speeds are possible. The source vacuum housing (not shown), which contains the mass spectrometer 500, includes a means for quickly changing the sample plate 102 without venting the system.

The mass spectrometer 500 includes a laser desorption pulsed ion source 104. In one embodiment, the pulsed ion source 104 comprises a two-field pulsed ion source. The pulsed ion source 104 includes a laser 106 that irradiates a sample positioned on the sample plate 102 to generate ions. For example, one suitable laser 106 is a frequency tripled Nd:YLF laser operating at 5 kHz. In some embodiments, the pulsed ion source 104 comprises a matrix-assisted laser desorption/ionization (MALDI) pulsed ion source. However, it should be understood that non-MALDI pulsed ion sources can be used with the mass spectrometer of the present teaching.

Ion source optics is positioned after the pulsed ion source 104. The ion source optics is designed for high-resolution mass spectra measurements. An extraction electrode 107 is positioned adjacent to the sample plate 102. A first 108 and a second ion deflector 110 are positioned after ion source 104 in the path of the ion beam. The first and second ion deflectors 108, 110 deflect the ion beam to an ion fragmentation chamber 118 positioned proximate to the output of the second ion deflector 110.

In some embodiments, the first and second ion deflectors 108, 110 deflect the ion beam at a predetermined angle that reduces ion trajectory errors that limit the resolving power of the mass spectrometer. In some embodiments, the second ion deflector 110 deflects the ions at a relatively wide angle compared with known time-of-flight mass spectrometers.

A first pulsed ion accelerator 116 is positioned after the pulsed ion source 104 in the path of the ion beam. In some embodiments, the first pulsed ion accelerator 116 is positioned in the path of the ion beam in the space between the second ion deflector 110 and the first ion fragmentation chamber 118 as shown in FIG. 2. In other embodiments, the first pulsed ion accelerator 116 is positioned in the path of the ion beam between the first ion deflector 108 and second ion deflector 110. A first timed ion selector 114 is positioned adjacent to the first ion accelerator 116 to direct certain accelerated ions to the fragmentation chamber 118 and to deflect all other ions away from first fragmentation chamber 118. In one embodiment, the first timed ion selector 114 is positioned before the first pulsed ion accelerator 116 as shown in FIG. 5. In other embodiments, the first timed ion selector 114 is positioned in the ion path after the first ion accelerator 116.

One skilled in the art will appreciate that any type of fragmentation chamber can be used. In one embodiment, the first fragmentation chamber 118 is a collision cell containing a collision gas and an RF-excited octopole that guides fragment ions. The first ion fragmentation chamber 118 fragments some of the precursor ions. A differential vacuum pumping system can be included that prevents excess collision gas from significantly increasing pressure in the tandem TOF mass spectrometer 500.

The first ion fragmentation chamber 118 fragments the selected precursor ions. A second pulsed ion accelerator 150 accelerates and focuses precursor ions and fragment ions from the first ion fragmentation chamber 118. A second ion fragmentation chamber 152 further fragments precursor ions and fragment ions accelerated by the second pulsed ion accelerator 150. A second timed ion selector 120 selects fragment ions formed by fragmentation of selected precursor ions in first ion fragmentation chamber 118 and transmits selected ions and fragments thereof from second fragmentation chamber 152 to a third pulsed ion accelerator 122 that accelerates and focuses fragment ions exiting the second ion fragmentation chamber 152. Fragment ions are accelerated by the third pulsed ion accelerator 122. The fragment ions are then further accelerated by a static accelerator 132. The accelerated fragment ions are then reflected by the ion mirror 124 and directed along the ion trajectory 136 through the field-free space 126. Finally, the ion fragments are detected by a detector 128. An ion fragment spectrum for each selected ion fragment of each selected precursor ion can be simultaneously generated.

In one embodiment, the first and second timed ion selectors 114 and 120 are Bradbury-Nielsen type ion shutters or gates. As described in connection with FIG. 2, a Bradbury-Nielsen type ion shutter or gate is an electrically activated ion gate that includes parallel wires positioned orthogonal to the path of the ion beam. These gates only pass charged particles at certain times in the waveform cycle when the voltage difference between wires is near zero. At other times, the ion beam is deflected to some angle by the potential difference established between the neighboring wires. The wires are oriented so that ions rejected by the timed ion selector 114 are deflected away from the exit aperture.

The second timed ion selector 120 selects fragment ions formed by fragmentation of selected precursor ions in the first ion fragmentation chamber 118 and transmits selected ions and fragments thereof from the second fragmentation chamber 152 to a third pulsed ion accelerator 122. The second timed ion selector 120 passes ions with a desired mass-to-charge ratio range and rejects all other ions in the ion beam. The ions passed by the timed ion selector 120 enter into a second pulsed ion accelerator 122 where selected ions and their fragments are accelerated. In one embodiment, the second pulsed ion accelerator 122 further accelerates the ions and fragments thereof using a static electric field in region 132.

An ion mirror 124 is positioned after the second pulsed ion accelerator 122. The ion detector 128 is positioned after the ion mirror 124 in the electric field-free region 126. The ion mirror 124 is positioned such that ions reflected by the ion mirror 124 travel along trajectory 136 through the field-free region 126 and are focused at ion detector 128. In one embodiment, the ion detector 128 is a discrete dynode electron multipliers, such as the MagneTOF detector, which is a sub-nanosecond ion detector with high dynamic range. The MagneTOF detector is commercially available from ETP Electron Multipliers. The ion detector 128 can be coupled to a transient digitizer, which can perform signal averaging.

It should be understood by those skilled in the art that the schematic diagram shown in FIG. 5 is only a schematic representation and that various additional elements would be necessary to complete a functional mass spectrometer. For example, power supplies are required to power the pulsed ion source 104, the deflectors 108, 110, the timed ion selectors 114 and 120, the ion mirror 124, the pulsed accelerators 116, 150, and 122, and the detector 128. In addition, a vacuum pumping arrangement is required to maintain the operating pressures in the vacuum chamber housing of the mass spectrometer 100 at the desired operating levels.

The mass spectrometer 500 can operate in various modes and can provide high mass resolving power for precursor selection and for obtaining MS, MS-MS, and MS-MS-MS spectra. In various embodiments, the mass spectrometer 500 can be configured for measuring either positive or negative ions, and can be readily switched from one type of ion to the other type of ions.

Some of the various modes of operation require that some spectrometer 500 components be deactivated. For example, when operating the TOF-TOF mass spectrometer 500 in the reflector MS mode, the pulsed accelerators 116, 150, and 122, the ion fragmentation chambers 118 and 152, and the timed ion selectors 114 and 120 are all deactivated. Instead, electrical potentials are applied to the ion mirror 124 that are chosen to direct ions along trajectory 136 so they can be detected by the ion detector 128.

When operating the TOF-TOF mass spectrometer 500 in the reflector MS mode, the ion mirror 124 generates one or more homogeneous, retarding, electrostatic fields that compensates for the effects of the initial kinetic energy distribution of the ions. As the ions penetrate the ion mirror 124 and experience the electrostatic fields, they are decelerated until the velocity component of the ions in the direction of the electric field becomes zero. Then, the ions reverse direction and are accelerated back through the ion mirror 124. The ions then exit the ion mirror 124 with energies that are identical to their incoming energy, but with velocities that are in the opposite direction. Ions with larger energies penetrate more deeply into the ion mirror 124 and, consequently, will remain in the ion mirror 124 for a longer time. In a properly designed ion mirror, the potentials are selected to modify the flight paths of the ions such that the travel time between the focal points for the ion mirror 124 for ions of like mass and charge is independent of their initial energy.

When operating the TOF-TOF mass spectrometer 500 in the MS-MS mode, the second pulsed accelerator 150 is deactivated and the first pulsed accelerator is adjusted to focus selected precursor ions at the second timed ion selector 120. When operating the TOF-TOF mass spectrometer 500 in both the MS-MS and the MS-MS-MS modes, the selected precursor ions and fragments thereof are accelerated by the pulsed ion accelerator 122. This acceleration separates the fragments from the precursor ions and allows fragment masses to be accurately determined from the resulting time-of-flight spectra. The precursor ions and fragments thereof are then directed to the ion mirror 124. The ion mirror 124 generates one or more homogeneous, retarding, electrostatic fields that further compensates for the effects of the initial kinetic energy distribution of the ions. The selected ions and fragments thereof are then reflected by the ion mirror 124 so they travel through a field-free region 126 and are then focused to ion detector 128.

In one embodiment, a third timed ion selector (not shown) is located adjacent to the exit from pulsed accelerator 122. In this embodiment, a portion of the fragment ion spectrum from each precursor ion is selected by the third timed-ion-selector and is then transmitted to the ion mirror 124 with the remaining portion of the fragment spectrum being deflected away from a second ion detector. In this embodiment, the masses of any two precursor ions of the predetermined set of ions may differ by as little as 1 percent.

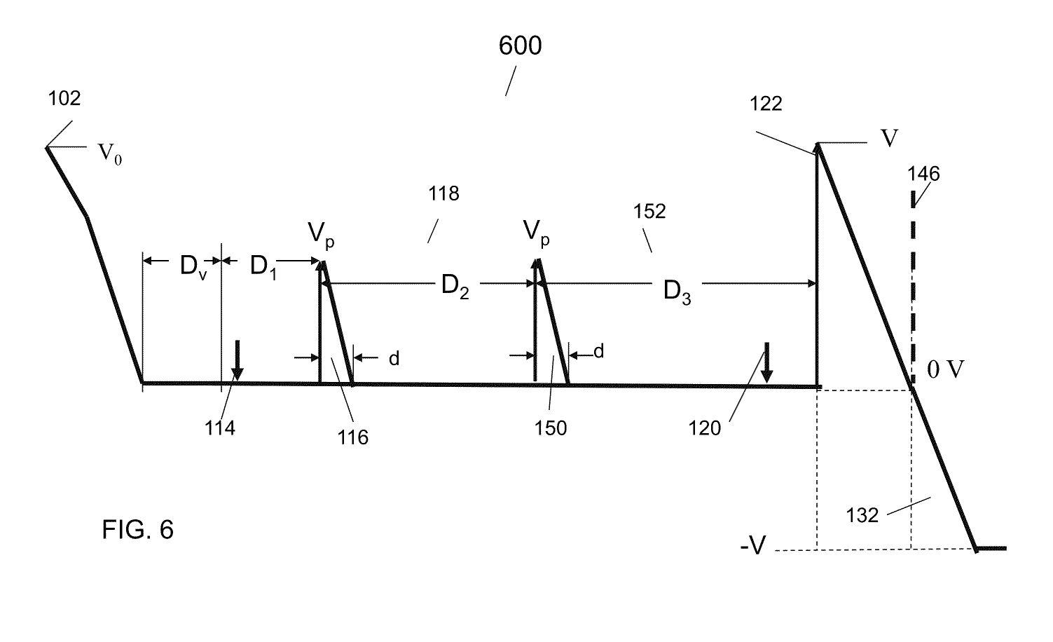

FIG. 6 shows a potential diagram 600 for a portion of the first time-of-flight mass analyzer in the tandem TOF mass spectrometer 500 with high resolution precursor selection and multiplexed MS-MS operation. Referring to both the tandem TOF mass analyzer 500 shown in FIG. 5 and the potential diagram 600, when an ion generated by the pulsed ion source 102 substantially reaches the center of the first pulsed accelerator 116, an accelerating voltage pulse Vₚ is applied to the ion accelerator 116. If the ratio of the amplitude of the accelerating voltage pulse Vₚ to the energy Vₒ of ions exiting the ion mirror 124 is equal to 4d/D₁, where d is the length of the first pulsed accelerator 116, and D₁ is the distance from the first order velocity focal point of the pulsed ion source 102 to the center of the first pulsed accelerator 116, then the velocity spread of the ions exiting the ion accelerator 116 is substantially reduced to zero and the velocity focus approaches infinity.

At relatively high pulse amplitudes, Vₚ, the velocity distribution is inverted and the velocity focus can be made to occur at any required distance. At relatively low pulse amplitudes, Vₚ, the velocity distribution is broadened. After focusing with the first pulsed accelerator, the velocity distribution is reduced by the factor (D2/D1)(1+4d/D₁)^{1/2}, where D₂ is the distance from the center of the first pulsed accelerator 116 to the entrance to the second timed ion selector 120. In one embodiment, the distance D₂ from the first pulsed accelerator 116 to the second timed ion selector 120 is more than 10 times the distance D₁ from the velocity focus for the pulsed ion source 102 to the first pulsed accelerator 116. Thus, a relatively broad velocity distribution at the velocity focal point for the pulsed ion source can be effectively removed, thereby allowing high performance measurements of both precursor ion and fragment mass.

Thus, a tandem TOF mass spectrometer according to the present teaching provides simultaneous optimization of performance of both the first TOF mass spectrometer and the second TOF mass spectrometer in a tandem TOF mass spectrometer. In multiplex operation of the tandem TOF mass spectrometer according to the present teaching, a predetermined group of precursor ions are selected following each laser pulse or ionization event of the pulse ionization source. Each precursor ion in the predetermined group of precursor ions is selected by the first timed ion selector and all other ions are rejected. In the MS-MS mode of operation, the selected precursor ions are fragmented and the fragment ions are analyzed in the second mass spectrometer.

In the MS-MS-MS mode of operation, the selected precursor ions are fragmented in a first ion fragmentation chamber, and the selected precursor ions and fragments thereof are accelerated by a pulsed accelerator causing the selected precursor ions and associated fragments to separate in time as they pass through a second ion fragmentation chamber. A second timed ion selector selects predetermined fragments from the first ion fragmentation chamber and transmits selected ions and fragments formed in the second ion fragmentation chamber to the second mass spectrometer to generate the MS-MS-MS spectra. Multiple fragments from each precursor ion can be selected and further fragmented to allow multiplex operation in MS-MS-MS mode.

The methods and apparatus of the present teaching can be used to identify molecules of interest present in complex mixtures using a TOF mass spectrometer with multiplexed MS, MS-MS, and MS-MS-MS operation. One method according to the present teaching includes determining masses of molecular ions by generating a time-of-flight MS spectra from precursor ions generated by MALDI. However, one skilled in the art will appreciate that numerous other ionization means can be used. A group of the molecular precursor ions following each MALDI ionization event is selected. At least a portion of the group of selected precursor ions is then fragmented. Time-of-flight MS-MS spectra of fragment ions for each of the selected precursors is then simultaneously generated.

At least a portion of a group of fragment ions from each selected precursor ion is then selected for further fragmenting. MS-MS-MS time-of-flight spectra of fragment ions are simultaneously generated for each of the selected fragments and precursor ions. Molecules of interest can then be simultaneously identified by interpreting the MS, MS-MS, and MS-MS-MS spectra with a processor.

### EQUIVALENTS

While the applicant's teachings are described in conjunction with various embodiments, it is not intended that the applicant's teachings be limited to such embodiments. On the contrary, the applicant's teachings encompass various alternatives, modifications, and equivalents, as will be appreciated by those of skill in the art, which may be made therein without departing from the spirit and scope of the teaching.

What is claimed is:

1. A tandem TOF mass spectrometer comprising:
a) a first TOF mass analyzer that generates an ion beam comprising a plurality of ions and that selects a group of precursor ions from the plurality of ions;
b) a first pulsed ion accelerator positioned to receive the selected group of precursor ions, the first pulsed ion accelerator accelerating the selected group of precursor ions;
c) a first ion fragmentation chamber positioned to receive the selected group of precursor ions that is accelerated by the first pulsed ion accelerator, the first ion fragmentation chamber fragmenting at least some of the selected group of precursor ions;
d) a second pulsed ion accelerator positioned to receive the selected group of precursor ions and fragments thereof from the first ion fragmentation chamber, the second pulsed ion accelerator accelerating the selected group of precursor ions and fragments thereof;
e) a second ion fragmentation chamber positioned to receive the selected group of precursor ions and fragments thereof that are accelerated by the second pulsed ion accelerator, the second ion fragmentation chamber further fragmenting at least some of the selected group of precursor ion fragments; and
f) a second TOF mass analyzer that receives the selected group of precursor ions and fragments thereof from the second ion fragmentation chamber, the second TOF mass analyzer separating the fragments and detecting a fragment ion mass spectrum.

2. The mass spectrometer of claim 1 further comprising a MALDI ionization source that generates the ion beam.

3. The mass spectrometer of claim 1 further comprising an ion mirror positioned after the second pulsed ion accelerator, the ion mirror reflecting precursor ions and fragments thereof into the second TOF mass analyzer.

4. The mass spectrometer of claim 1 further comprising a processor for interpreting the fragment ion mass spectrum to simultaneously identify molecules of interest.

5. The mass spectrometer of claim 1 wherein the second TOF mass analyzer further comprises a field-free drift space that is biased with a static accelerating electric field which accelerates the fragment ions from each precursor.

6. The mass spectrometer of claim 1 wherein the second pulsed ion accelerator refocuses the selected group of precursor ions and fragments thereof.

7. The mass spectrometer of claim 1 wherein the second pulsed ion accelerator refocuses the selected group of precursor ions and fragments thereof.

8. A tandem TOF mass spectrometer comprising:
a) a pulsed ion source that generates a pulse of precursor ions from a sample to be analyzed;
b) a first pulsed ion accelerator positioned to receive the pulse of ions, the first pulsed ion accelerator accelerating the precursor ions;
c) a first timed ion selector positioned to receive the precursor ions accelerated by the first pulsed accelerator, the first timed ion selector selecting a group of precursor ions;
d) a first ion fragmentation chamber positioned to receive the selected group of precursor ions, the first ion fragmentation chamber fragmenting at least some of the group of precursor ions;
e) a second pulsed ion accelerator positioned to receive the group of precursor ions and fragments thereof from first ion fragmentation chamber, the second pulsed ion accelerator accelerating the group of precursor ions and fragments thereof;
f) a second ion fragmentation chamber positioned to receive the group of precursor ions and fragments thereof accelerated by the second pulsed ion accelerator, the second ion fragmentation chamber fragmenting at least some of the fragments;
g) a second timed ion selector positioned to receive the group of precursor ions and fragments thereof and the fragments generated in the second ion fragmentation chamber, the second timed ion selector selecting a narrow range of masses centered on each selected fragment ion;
h) a third pulsed ion accelerator that is positioned to receive the selected group of precursor ions and fragments selected by the second timed ion selector, the third pulsed ion accelerator accelerating the selected precursor ions and fragments; and
i) an ion detector positioned in a path of the accelerated selected precursor ions and fragments, the ion detector detecting precursor ions and fragments, wherein a flight time from the third pulsed ion accelerator to the ion detector is dependent on a mass-to-charge ratio of the selected precursor ions and fragments thereof and nearly independent of an initial velocity distribution of ions in the pulse of ions.

9. The mass spectrometer of claim 8 wherein the pulsed ion source comprises a MALDI pulsed ionization source.

10. The mass spectrometer of claim 8 further comprising an ion mirror having an input that is positioned in a path of the ions accelerated by the third pulsed ion accelerator, the ion mirror generating a reflected ion beam that is directed to the ion detector.

11. The mass spectrometer of claim 8 further comprising a processor for interpreting the fragment ion mass spectrum to simultaneously identify molecules of interest.

12. The mass spectrometer of claim 8 wherein the first pulsed ion accelerator refocuses the precursor ions.

13. The mass spectrometer of claim 8 wherein the second pulsed ion accelerator refocuses the group of precursor ions and fragments thereof.

14. A method of measuring MS-MS-MS spectra, the method comprising:
a) performing a first TOF mass analysis by generating an ion beam comprising a plurality of ions and then selecting a group of precursor ions from the plurality of ions;
b) accelerating the selected group of precursor ions;
c) fragmenting at least some of the selected group of precursor ions;
d) accelerating at least some of the selected group of precursor ions and fragments thereof;
e) fragmenting at least some of the accelerated fragment ions;
f) selecting at least some of the accelerated fragment ions and fragments thereof; and
g) performing a second TOF mass analysis by separating the ion fragments and detecting a fragment ion mass spectrum.

15. The method of claim 14 wherein the generating the ion beam comprising generating an ion beam with a MALDI pulsed ion source.

16. The method of claim 14 wherein the performing the first TOF mass analysis further comprises focusing the pulse of ions into an ion beam.

17. The method of claim 14 wherein the performing the first TOF mass analysis further comprises generating a reflected ion beam with an ion mirror.

18. The method of claim 14 wherein the selecting the group of precursor ions from the plurality of ions comprises selecting precursor ions with time-of-flights that are substantially independent of a path traveled.

19. The method of claim 14 wherein the performing the first TOF mass analysis and the performing the second TOF mass analysis are independently optimized.

20. The method of claim 14 wherein the accelerating the selected group of precursor ions further comprises focusing the selected group of precursor ions.

21. The method of claim 14 further comprising accelerating the selected precursor ions and fragments thereof.

22. The method of claim 14 further comprising selecting a predetermined portion of the fragment ions from each precursor.

23. The method of claim 14 further comprising biasing a field-free drift space with a static accelerating electric field that accelerates the fragment ions from each precursor.

24. A method for identifying molecules of interest present in complex mixtures using a TOF mass spectrometer with multiplexed MS, MS-MS, and MS-MS-MS operation, the method comprising:
a) determining masses of molecular precursor ions by generating a time-of-flight MS spectra from precursor ions;
b) selecting a plurality of the molecular precursor ions following each ionization event, fragmenting at least a portion of the selected plurality of molecular precursor ions, and simultaneously generating time-of-flight MS-MS spectra of fragment ions for each of the selected molecular precursor ion;
c) selecting a plurality of the fragment ions from each selected molecular precursor ion and fragmenting at least a portion of the fragment ions, and simultaneously generating MS-MS-MS time-of-flight spectra of fragment ions for each selected fragment and precursor; and
d) interpreting MS, MS-MS, and MS-MS-MS spectra to simultaneously identify each of the molecules of interest.

25. The method of claim 25 wherein the precursor ions are generated by MALDI.
